(19) United States
(12) Patent Application Publication
(10) Pub. No.: US 2003/0209375 A1
(43) Pub. Date: Nov. 13, 2003

(54) Electrical vehicle energy supply system, electrical vehicle battery, electrical vehicle battery charging apparatus, battery supply apparatus, and electrical vehicle battery management system

(75) Inventors: Furmio Suzuki, Tokyo (JP); Kiichi Takase, Tokyo (JP); Jack D. Dwosh, Los Angeles, CA (US)

Correspondence Address: HARRIS BEACH LLP, 99 Garnsey Road, Pittsford, NY, 14534, US

(73) Assignee: Zip Charge Corporation

(21) Appl. No.: 10/336,097

(22) Filed: Jan. 3, 2003

Related U.S. Application Data
(63) Continuation of application No. 09/489,815, filed on Jan. 24, 2000, now abandoned.

(30) Foreign Application Priority Data
Jan. 25, 1999 (JP) 15628/1999
Jun. 7, 1999 (JP) 160039/1999

(51) Int. Cl. B60L 11/18; H02J 7/00

(52) U.S. Cl. 180/65.3; 180/68.5; 320/112; 320/109

(57) ABSTRACT

An electrical vehicle energy supply system has an electrical vehicle which carries in a prescribed location a freely removable cassette-type battery and an energy supply station which has at all times a plurality of the cassette-type batteries and which performs charging processing of units of these batteries which include the number of batteries required by one such electrical vehicle, and performs the function of storing said batteries in a fully charged condition. In this system, when an electrical vehicle enters the energy supply station, all of the batteries are removed therefrom, these being replaced by an equal number of fully charged batteries that had been stored at the energy supply station, the single or multiple batteries that had been removed from the electrical vehicle being charged, the electrical vehicle heading toward a next energy supply station and the energy supply station awaiting the arrival of a next electrical vehicle.

### BACKGROUND OF THE INVENTION

1. Field of the Invention

The present invention relates to an electrical vehicle energy supply system, and more particularly to an electrical vehicle energy supply system that is capable of supplying energy to an electrical vehicle with the same convenience as possible in the past with respect to gasoline-engine vehicles.

2. Description of the Related Art

In recent years, research and development work has been conducted with the aim of achieving a practically usable electrical vehicle, and the electrical vehicle is gaining attention as the ideal environmentally friendly vehicle to protect the natural environment.

At the present time, however, there is a large problem involved with the method of supply of electrical energy to be used in the electrical vehicle as a source of drive, and with regard to the method of maintaining a long-lasting charge so as to impart a long operating range to the electrical vehicle. The first problem is that of insufficient battery charge capacity, making it necessary to use a batter that is both large and heavy, not only imposing limits with regard to design, but also involving an inevitable increase in load, because of the weight of the battery itself, thereby making such vehicles completed unsuited for long periods of driving or long-distance driving.

Moreover, charging batteries in the past required 3 to 10 hours, or even longer, making it impossible to supply energy easily or efficiently. Thus, compared with previously used energy supply systems, such as gasoline, diesel fuel, or natural gas, the electrical vehicle provided inferior functionality, this being a great hindrance to its practical adoption.

One method that has been envisioned as a battery improvement recently is that of a battery that makes use of a fuel cell.

However, because of the hydrogen that a fuel cell uses as a raw material, the degree of danger, for example, in an energy supply system such as at a gasoline station would be so great, that it was thought to be impossible to use such a battery as a practical energy supply system for electrical vehicles. With technological developments in recent years, however, even with a fuel cell, use as a removable cassette-type battery has become possible. Therefore, it is possible to apply the present invention to secondary cells such as lead batteries, nickel-cadmium batteries, nickel-hydrogen batteries, nickel-zinc batteries, nickel-metal wet batteries, three-terminal lead-cobalt batteries, sodium-sulfur batteries, lithium ion batteries, lithium polymer batteries, and fuel cells.

Therefore, the required conditions for the practical use of a battery in an electrical vehicle in the future are lightness and absence of any great design load on the vehicle, ease of use and handling, the ability to be charged in a short period of time, and the implementation of a charging system that is capable of fully or nearly fully charging the battery reliably in a short period of time, all of these capabilities being matched in an cooperative manner.

In the case in which such energy were to exist in major urban areas such as gasoline station are at present, no currently available battery or current usable charging method would enable a vehicle to received energy, that is, to be electrically charged and, after completion of the energy supply, to be paid for and leave the energy station subsequent vehicles are waiting in line, these being charged in the same manner and leaving the station in the same manner after charging.

In locations such as Japan, which are crowded, even given the existing distribution of gasoline stations, the amount of parking and stopping space available for vehicles to wait to be supplied with energy in the form of gasoline is physically limited to within 3 vehicles, making it impossible to obtain space for parking or stopping any further vehicles.

In consideration of the above-noted situation, should a practical electrical vehicle be developed and a network of numerous energy supply stations such as exists for gasoline vehicles be built, with electrical vehicles stopping into these stations to receive electrical energy, the required reasonable amount of time to supply energy to the electrical vehicle should not be greater than 5 minutes.

If a charging system existed to enable charging in 7 to 9 minutes, it would be a charging system with a 6C charging rate, that is, the maximum time would be 10 minutes.

However, the current methods used for actual charging of the small batteries in electrical tools performing charging in 10 minutes at a 6C charging rate, using a minus delta V method. In this method, because the charging is done with the battery at a considerably elevated temperature, the life of the battery cell is significantly shortened, making it necessary to purchase a new battery after a short period of time.

If the above-noted method were to be applied as the method of charging an electrical vehicle battery, it would be necessary to frequently replace the large, high-cost battery used in the electrical vehicle, making the system an expensive one, even if the battery were to be supplied through a leasing system.

In previously developed electrical vehicles, there was a motor and a battery part, this consisting of a large number of batteries used to drive the motor, these being installed as one in the engine part of the vehicle, making it impossible to remove the batteries simply.

If there is a desire to perform high-speed charging at a rate of 4C or 6C, for example, the switching regulator power source becomes expensive, thereby making the electrical vehicle expensive.

If 4C or 6C charging is to be done at home, because the normal home distribution panel only provides a capacity of 30 A or 40 A, it becomes necessary to provide a transformer apparatus at the home.

Such high-speed charging means, therefore, requires an external charging station.

In the Japanese Unexamined Patent Publication (KOKAI) No. 10-307962, 10-307964, and 10-307952, there are disclosures of an automatic rental system for bicycles provided with an auxiliary driving mechanism driving by a motor having a battery as a driving power supply, wherein the battery can be replaceable, and further wherein the battery is loaned at the time a bicycle is loaned.

In this rental system, all that is done is that the loaning and returning of the bicycle are linked together with the loaning and returning of the battery, so that the bicycle and the battery are treated as one item, there being no free distribution of the battery itself.

Accordingly, it is an object of the present invention to improve on the drawbacks as described above in the prior art, by providing an electrical energy supply system that is capable of supplying energy to an electrical vehicle with the same convenience as would be possible in supplying energy to a gasoline vehicle.

### SUMMARY OF THE INVENTION

In order to achieve the above-noted object, the present invention adopts the following basic technical constitution.

Specifically, a first aspect of the present invention is an energy supply system for an electrical vehicle that has an electrical vehicle which runs by means of drive from an electrical motor driven by a battery, a cassette-type battery that can be freely installed into and removed from the electrical vehicle, and a battery storage location for the cassette-type batteries provided in proximity to the path of travel of the electrical vehicle, wherein when a need arises to replace the cassette-type battery of the electrical vehicle, an owner or user of the electrical vehicle returns the battery to the battery storage location and replaces it with a different cassette-type battery from the battery storage location that has been charged, or easily obtains from a type of automatic vending machine located at a convenient nearby location, and which operates as a branch of the battery storage location, a charged electrical vehicle cassette-type battery, in return for payment, and installs this cassette-type battery into the electrical vehicle.

The second aspect of the present invention is an energy supply system for an electric vehicle that has an electrical vehicle which carries in a prescribed location a freely removable cassette-type battery of a prescribed shape, an energy supply station which has at all times a plurality of the cassette-type batteries of a prescribed shape, and which performs charging processing of units of these batteries which include the number of batteries required by one such electrical vehicle, and serves the function of storing the batteries in a fully charged condition. In this system, when an electrical vehicle enters the energy supply station, part or all of the batteries are removed therefrom, these being replaced by an equal number of fully charged batteries that had been stored at the energy supply station, the single or multiple batteries that had been removed from the electrical vehicle being charged, the electrical vehicle heading toward a next energy supply station and the energy supply station awaiting the arrival of a next electrical vehicle.

The electrical vehicle related to the present invention is a general electrical vehicle driven by an electrical motor having a battery as a drive power source, and of course includes a general type of automobile, truck, bus, in addition to an electrical bicycle, an electrical motorcycle, a forklift, and other types of work-related vehicles used at an airport or factory, exhibition halls, and work vehicles used to perform work under dangerous environmental conditions. It also includes golf carts, wheelchairs used by the disabled, toy vehicles, various amusement park rides, and electrical track-borne vehicles.

In the electrical vehicle energy supply system according to the present invention, the batteries that are fixed into the electrical vehicle in the past are changed to replaceable cassette-type batteries that can be easily installed and removed, so that when the electrical vehicle stops by at the energy supply station, this cassette can be replaced by a cassette of the same type that is made ready and is fully charged, thereby completing the process of supplying energy to the electrical vehicle, after which the cassette-type battery or batteries that had been removed from the vehicle are charged at the energy supply station, which then awaits the arrival of the next vehicle for charging.

Thus, in the present invention, the battery part of the electrical vehicle, which in the past was part of the vehicle, is replaced by a number of cassette-type batteries of a uniform specification type, a these cassette-type batteries being distributed to a large number of electrical vehicles and a large number of energy supply stations, battery storage locations, and automatic vending machines, by leasing or rental, or by individual sales, the payment for this being achieved by the owner or user of the vehicle paying for the energy by paying for the amount of electricity charged into the cassette-type battery.

Additionally, in the present invention, in each of the cassette-type batteries, in addition to battery information, historical information about the charging condition is recorded and held, and minimally before and after charging the charging recorded of each battery is monitored, thereby enabling a judgment to be made with regard to the battery characteristics. Thus, if a judgment is made that the battery has deteriorated, the battery in question can be removed from the electrical vehicle energy supply system charging and supply system.

Essentially, in contrast with the above-noted prior art, the present invention accommodates vehicles, which have a radius of activity that is far beyond that of a bicycle and, whereas the owner of the vehicle is an individual (but can, of course, also be a rental company), the globally standard cassette-type batteries can be easily purchased for use at any time in exchange for payment at a prescribed spot having the function, for example, of a gasoline station, thereby enabling the easy purchase of electrical energy. Batteries that have become depleted, in consideration of environmental problems, are returned to such as prescribed spot, charged, and then reused.

### BRIEF DESCRIPTION OF THE DRAWINGS

FIG. 1 is drawing illustrating the configuration of an example of an electrical vehicle energy supply system according to the present invention.

FIG. 2 is a drawing showing an example of the configuration of a cassette-type battery that is installed in an electrical vehicle that is used in an electrical vehicle energy supply system according to the present invention.

FIG. 3 is a drawing showing an example of the position of a cassette-type battery in an electrical vehicle.

FIG. 4 is a drawing showing an example of cassette-type batteries that are stacked for use in the present invention.

FIG. 5 is a block diagram illustrating an example of the control path in an electrical vehicle energy supply system according to the present invention.

FIG. 6 is a block diagram showing an example of the storage means provided in a cassette-type battery used in the present invention and the peripheral circuitry.

FIG. 7 is a drawing showing an example of the shelf configuration that forms the storage space in an example of the storage function used in the present invention.

FIG. 8 (A) and FIG. 8 (B) are drawings illustrating an example of specific use of the storage function of the present invention.

FIG. 9 is a drawing illustrating an example of the configuration of an electrical vehicle energy supply system that is used in an electrical vehicle energy supply system according to the present invention.

FIG. 10 is a drawing that illustrates another example of an electrical vehicle energy supply system according to the present invention.

FIG. 11 is a drawing showing an example of the configuration of a battery storage location in the example of an electrical vehicle energy supply system according to the present invention shown in FIG. 10.

FIG. 12 is a drawing showing an automatic vending apparatus for electrical vehicle cassette-type batteries used in the present invention.

### DESCRIPTION OF THE PREFERRED EMBODIMENTS

Preferred embodiments of an energy supply system for en electrical vehicle according to the present invention are described in detail below, with references being made to the relevant accompanying drawings.

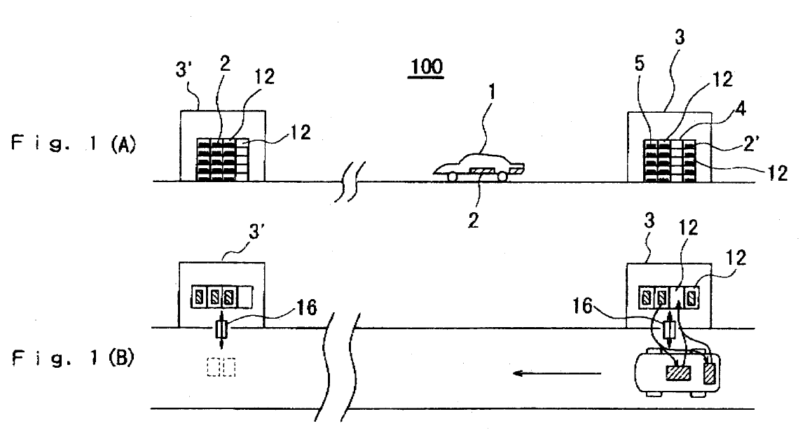

Specifically, FIG. 1 (A) and FIG. 1 (B) are drawings which generally illustrate an example of an electrical vehicle energy supply system according to the present invention. These drawings show an electrical vehicle energy supply system 100, which has an electrical vehicle 1 that into which is removably installed, at a prescribed position, a prescribed number of cassette-type batteries 2, and an energy supply station 3, which maintains a plurality of the cassette-type batteries 2 at all times, and which executes an operation of separately charging the number of batteries 2 required for one electrical vehicle 1 as a unit 5 and has a function of storing fully charged battery groups. When an electrical vehicle 1 stop into the energy supply station 3, part or all of the battery groups 2 currently installed in the electrical vehicle 1 are removed, and are replaced with the same number of batteries 2′ that are stored at the energy supply station 3 that have been fully charged, the one or several batteries 2 that were removed from the energy supply station 3 being charged at the energy supply station 3, the electrical vehicle 1 heading for the next energy supply station 3′, and the energy supply station 3 waiting for the arrival of another electrical vehicle.

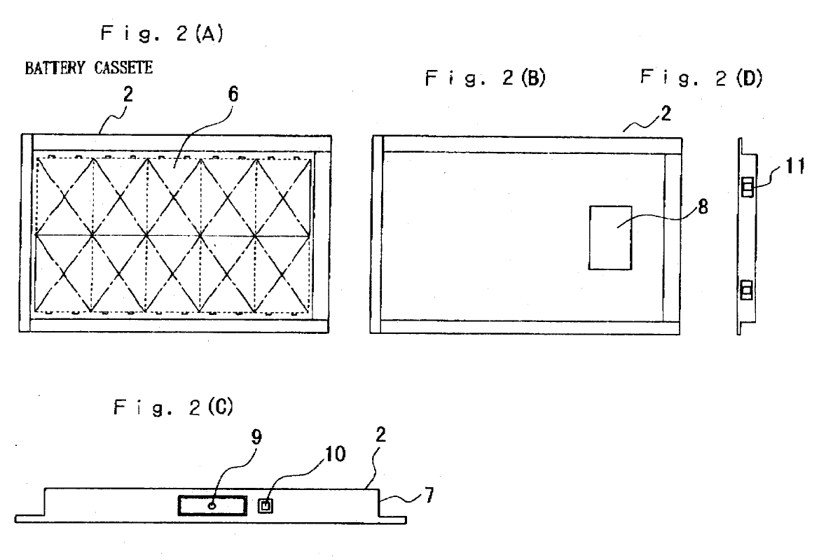

The above-noted battery 2 that is installed in the electrical vehicle 1 of the present invention, as shown in FIG. 2 (A) through FIG. 2 (D), is preferably of flat construction, formed by a plurality of battery cells 6 that are arranged in a planar manner, so that the outer shape of the battery 2 is itself flat.

In the battery 2 that is used in the present invention, as shown in FIG. 2 (A), a plurality of battery cells 6 are mutually connected by appropriate electrical wiring, thereby forming a single cassette-type battery pack.

Additionally, in the present invention the cassette-type battery is provided with an outer frame 7 of an appropriate material that covers the battery cells 6, this outer frame 7 not only greatly improving the ease of the battery, but also enabling the removable installation of the battery in a flat shape in locations such as under the floorboards of the electrical vehicle or under the trunk compartment, these being locations at which a change in the design is relatively difficult.

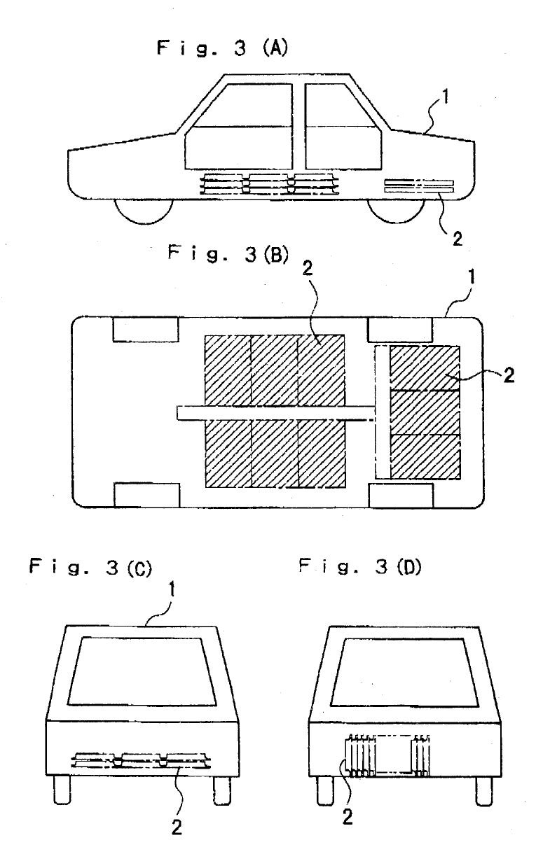

Thus, in the present invention, because the weight of each battery cassette 2 is approximately 20 kg, the installation-location thereof greatly affects the balance of the electrical vehicle. For this reason, as shown in FIG. 3, it is thought to be best to install them at the bottom of the center part of the vehicle. Because the heavy motor inverter and other heavy components are disposed at the front part of the electrical vehicle, it is best to locate the batteries at the center and rear parts, so as to achieve a good balance.

FIG. 3 (A) through FIG. 3 (C) are drawings that show the configuration of an example of a electrical vehicle 1 into which are removably installed the cassette-type battery 2 of the present invention.

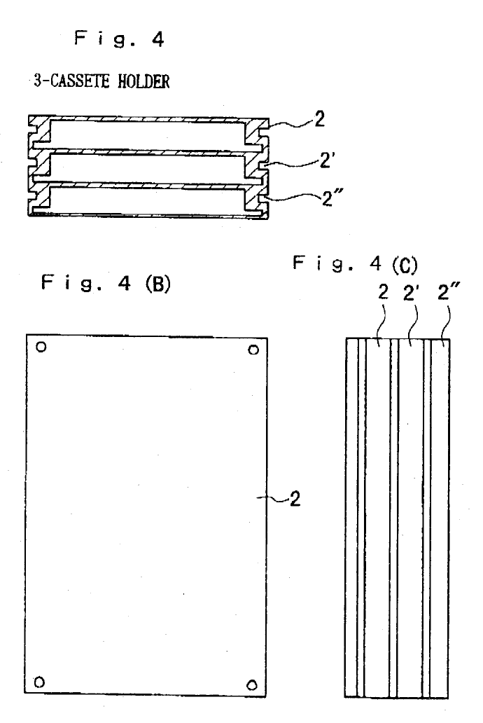

In the present invention, the electrical vehicle can have a plurality of cassette-type battery groups 2 in one flat level, and it is preferable that, as shown in FIG. 4, the batteries 2 be either in one level or stacked to install them in the electrical vehicle.

FIG. 3 (D) is a drawing that shows how, rather than installing the cassette-type batteries 2 of the present invention horizontally, they can be installed at a prescribed angle with respect to the horizontal, thereby achieving a three-dimensional packaging, with a plurality of cassette-type batteries 2 used in a parallel aligned arrangement.

FIG. 3 (D) shows the example in which the cassette-type batteries 2, 2′, and 2″ are used in an attitude that is nearly perpendicular with respect to the horizontal attitude.

The installation position of the batteries 2 in a single electrical vehicle 1 of the present invention is preferably priorly established.

Additionally, in the present invention, while the number of cassette-type batteries 2 installed in an electrical vehicle 1 of the present invention is not particularly limited, it is preferable to have this number limited to a specific number.

Therefore, for example, it is desirable to establish three types of electrical vehicles 1, such as large, medium, and compact, and establish the number of cassette-type batteries 2 to be installed into each type of electrical vehicle 1.

Each of the cassette-type batteries 2 used in the present invention has a storage means 8 for storing information with regard to the charging condition, number of charges, remaining capacity, and internal resistance of the battery cells 6 contained therein, and information such as information with regard to the life of the cell 6 and the owner or user, and a display means 9 for selectively displaying information that is stored in the storage means.

In FIG. 2 (D), the reference numeral 11 denotes a connector which makes connection of the cassette-type battery 2 to an appropriate connection end of the electrical vehicle 1.

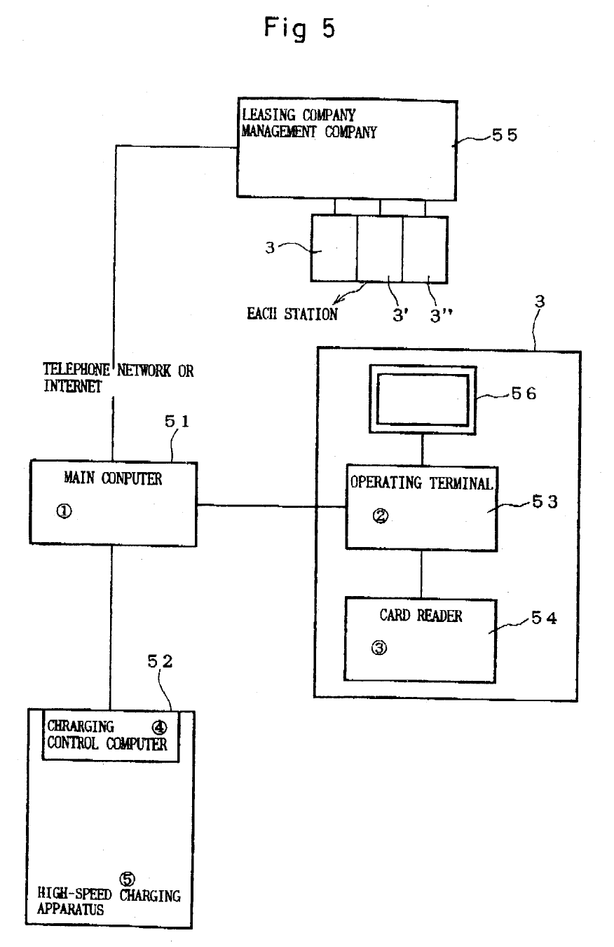

That is, it is desirable that in a battery management system according to the present invention, for example, a storage means that is at least one type selected from a group that consists of a semiconductor storage mechanism, an optical storage mechanism, a magnetic storage mechanism, and a storage means making use of an atom or molecule being mounted and, as shown in FIG. 5, this is connected in a contact or non-contact manner with a management computer 51. It is also desirable that the shape of the cassette-type battery 2 be made so as to facilitate the provision of a display apparatus 9, which displays the battery condition.

In the example that is shown in FIG. 5, for example, in the case in which a driver of a vehicle that has stopped into the energy supply station 3 for replacement of the batteries 2 of the electrical vehicle 1 is a member of a membership system that is operated by pre-established rules, a prescribed membership card is received from the member driver, this being inserted into a prescribed card reading apparatus 54, and a prescribed operating terminal means 53 displaying prescribed data from the card reader apparatus 54 on a prescribed display 56.

The contents of the display include such items as the membership number, the member's name, battery type, and the battery manufacture, and history items such as the date of the previous battery replacement, and number of previous battery replacements.

Then, the main computer 51, using for example telephone lines, accesses a computer of the battery 2 leasing company or management company to verify the information that is displayed, at which point the operating terminal means 53 is operated to send a charging start command to the charging management computer 52, via the main computer 51, so as to automatically perform the operation of replacing all or a desired number of the batteries installed in the electrical vehicle 1.

At the energy supply station 3, a monthly invoice is issued to members, based on the amount of charging time at the time of replacement of the battery 2 for the electrical vehicle 1, and from the amount of time from the previous battery replacement to the current battery replacement.

Other energy supply stations 3′ and 3″ are also connected to the above-noted leasing company or management company via an appropriate line.

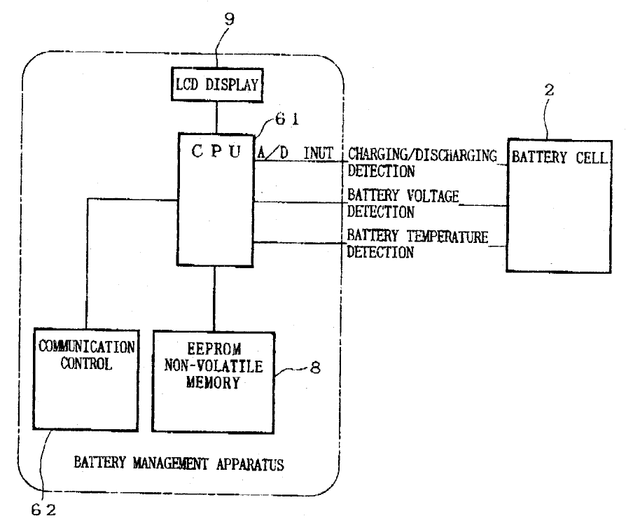

As shown in FIG. 6, a basic element in implementing an electrical vehicle energy supply system according to the present invention is the provision of a storage means 8 in each of the cassette-type batteries 2, by which the charging history for each cassette-type battery 2 can be verified at a glance.

Specifically, as shown in FIG. 6, the battery 2 has storage and display circuits that are implemented in the form of a non-volatile memory circuit 8, which is a memory such as an EEPROM, a CPU 16, a communication control means 62, and an LCD9.

While there is no particular restriction on the data that is written into the non-volatile memory 8, data that can be envisioned includes (1) the number of times and dates that the battery 2 has been charged, (2) the manufacturer and model of the battery 2, (3) the user number at the time of charging, and (4) information related to battery cell replacement.

A means of writing the above-noted information into the nonvolatile memory circuit 8 is, for example, that of writing the information into the storage means 8 of the cassette-type battery 2 in response to a charging start signal from the above-noted main computer 51.

In the present invention, the display means 9 of the battery 2 can display either the battery voltage or temperature value.

The management computer 1 of the present invention captures data at the point in time that the battery is charged, and performs management according to the customer number, registration number, and cassette number. The processing that is performed is to record such items from the data as the date of manufacture, the number of chargings, the date of charging, the manufacturer, the battery type, and historical data such as the maintenance record, so as to make a judgment with regard to replacement based on the life of the battery or judgment with regard to bad batteries.

In the present invention, it is possible to perform a good/bad judgment of a battery cell 6 within a battery 2 by measuring the internal resistance of the battery cell 6.

A procedure for writing and reading prescribed information into and from the storage means 8 of the battery 2 is, for example, to directly or in a non-contact manner perform writing of the above-noted data to the control apparatus of the cassette-type battery simultaneously with the occurrence of a charging start signal from the main computer and to read data therefrom using a non-contact method.

To do this, the internal resistance of each battery cell 6 in the cassette-type battery 2 is measured using an internal resistance meter, this being compared with a pre-established ideal internal resistance and, if the resistance reaches, for example, 80% or greater, the battery is replaced.

Replacement is done with a cassette-type battery manufactured to the same specifications, and is preferably done with a battery from the same manufacturer, of the same model, and having the same characteristics. Information with regard to a replaced battery is written into the IC card as a historical record. The data with regard to the internal resistances of each battery is used to make a judgment with regard to battery replacement.

Therefore, the cockpit panel at the driver's seat of the electrical vehicle 1 preferably has a means to display the capacity of the battery 2 of the electrical vehicle 1, and also this should display the deterioration condition of the battery based on the internal resistance thereof. By doing this, it is possible to easily determine the timing of the replacement of the battery 2 installed in the electrical vehicle 1, and it is possible also for an employee of the energy supply station 3 to gain a grasp of this condition.

An preferable example of a method of measuring the internal resistance of the battery 2 is that of performing the measurement while applying a high-frequency voltage thereto.

Additionally, it is desirable that each of the cassette-type batteries 2 be provided with a selection switching means for the purpose of selectively displaying prescribed information of the various information that is stored within the storage means of the battery 2.

A display means 9 that is usable in the present invention is, for example, an liquid-crystal display, and it is possible to display on this display means 9 either the battery voltage or the battery temperature.

In the present invention, it is preferable that the storage means 8 be an IC card, and it is desirable that this storage means 8 be a non-contact type IC card.

By adopting a membership type card system as described above with regard to the present invention, and adopting a means of storing prescribed information within the battery 2, when an attempt is made to charge a stolen vehicle, it is possible to determine the identity of the battery user or card owner or user, thereby contributing to the prevention of crime.

That is, in the case, for example, in which a membership card is lost, the previous membership number can be canceled and a new number issued, thereby guaranteeing the identity of the membership card owner at all times.

In this system, the cassette-type battery 2 that is used has within it a plurality of battery cells 6, and because it can be envisioned that there would be an attempt in the battery 2 distribution process to replace a battery cell of the battery 2 manufacturer that has the prescribed performance with an inferior, lower-cost cell and sell the battery 2 at an elevated price, to avoid such problems beforehand, it is desirable that, for example, a seal or key or the like that only officially recognized energy supply stations 3 can have be used to open the cover of the cassette-type battery 2 to enable replacement of a cell thereof.

This should be configured in such a manner that, if a third party improperly or without permission opens the cover of the battery 2 and replaces the battery cell 6 therewithin, it is possible to determine that this improper opening and replacement has occurred.

Naturally, this system can also be implemented by using a user personal identification number registered within a computer.

In a case in which a battery cell 6 has been removed from within the cassette-type battery 2, by adopting the configuration as shown in FIG. 6, in which a voltage that is applied to the cassette-type battery management apparatus is cut off, it is possible to store information with regard to whether or not the battery cell 6 has been improperly replaced.

In the above-noted case, it is possible to invalidate the membership card, making it unusable, or for the energy supply station 3 to reserve the right to demand damages imparted to the leased item.

In the case in which the cassette-type battery 2 is used as an individually owned item, it is possible to perform charging thereof at home, but if the charging system is not proper, because there is a good chance of overcharging, deep discharging, and heating occurring, it is possible to envision that the battery 2 will become deteriorated. Because the charging of such a deteriorated battery 2 at a energy supply station 3 will, depending upon the degree of deterioration, require a longer time, there is a chance that the charged amount, that is, the amount invoiced form the energy supply station 3 will be higher than in the case of the leasing system.

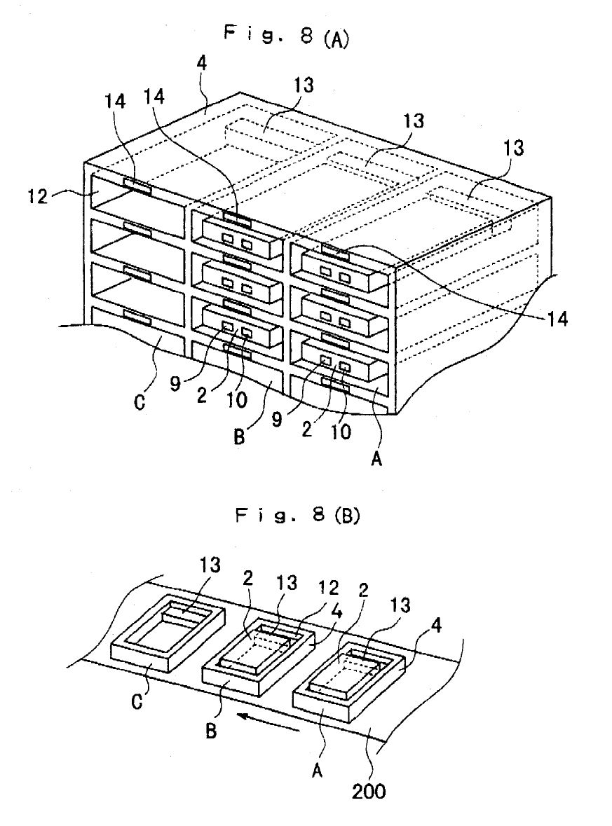

In an energy supply station 3 according to the present invention, a function 4 is provided which stores a group of batteries that are of a number that is sufficient for a single electrical vehicle 1, an example of this battery group storage function 4 being a box-shaped storage space 12, which is capable of storing these cassette-type batteries, and which also includes a charging circuit that can execute charging of the batteries when they are stored in the storage space. More specifically, as shown in FIG. 8 (A), this storage space 12 is a three-dimensional drawer, or arranged as a shelf.

Another example of a battery storage function 4 in the present invention, as shown in FIG. 8 (B), is that in which a plurality of storage spaces are provided on a moving conveyer 200.

In the box or shelf 12 that serves as the storage space in the present invention, a function 13 is provided that either simultaneously charges the group of batteries 2 therewithin or performs processing so as to maintain the charge of batteries 2 for which the charging process had been completed.

That is, in an electrical vehicle energy supply system according to the present invention, at each of the energy supply stations 3, 3′, and 3″ is provided a battery storage sections 4 having a plurality of storage spaces 4, the storage spaces 12 that form the battery storage section 4 being disposed according to a prescribed arrangement.

Additionally, in the present invention it is desirable that the size of one storage space 12 be such that it enables the storage of the number of batteries 2 required by a single electrical vehicle 1, although this is not an absolute requirement and, for example as shown in FIG. 8 (A), it is possible to have a configuration in which each one of the A, B, and C columns of shelves holds the number of battery 2 required by a single electrical vehicle 1.

As noted above, in the present invention because the charging history of the individual cassette-type batteries that are charged is stored in a prescribed storage means 8, and the configuration is such that the stored information can be read out to a display means 9, it is also possible to have a configuration in which the prescribed information can be stored from the above-noted charging operation means 13 in each of the shelves 12, which serve as the storage spaces in the storage section 4, into the storage means.

Each of the individual shelves 12, that serve as the storage spaces that form the storage means 4 in the present invention is provided with a display means 14 that is capable of displaying information such as the condition of the shelf 12, the charging condition, the charging status, and the remaining charge capacity.

Each of the storage spaces 12 in the battery storage section of the present invention is configured so as to be selectively placed in any of three condition, these conditions being a first condition, in which the space does not hold a battery 2, a second condition, in which the space holds a battery 2 and the battery is being charged, and a third condition, in which the space holds a battery and charging processing is performed to maintain the charge thereof.

That is, as shown in FIG. 8 (A), the shelves C are in the empty shelf condition and, in the case in which a prescribed electrical vehicle 1 pull into an energy supply station 3 for the purpose of receiving a supply of energy according to the present invention, these shelves C would receive the cassette-type batteries that are removed from the electrical vehicle 1, and these shelves would thus be in the above-noted first condition.

In FIG. 8 (A), the shelves A were in the same first condition as the shelves C last time and, by the stopping into the energy supply station 3 of an electrical vehicle 1, have received all or part of the removed cassette-type batteries 2 therefrom, and hold these batteries for charging therewithin, this condition being the above-noted second condition.

Further in FIG. 8 (A), the shelves B were in the same second condition as shelf A last time, the cassette-type batteries therein having already been charged, after which a trickle charge is being imparted to these batteries 2 to prevent discharging of the batteries 2, this being the above-noted third condition.

By an electrical vehicle 1 stopping into the energy supply station 3, after the cassette-type batteries 2 have been removed from the electrical vehicle 1, the shelf holding the batteries 2 charges the batteries and is in the second condition.

Therefore, in the condition that is shown in FIG. 8, in the case in which an electrical vehicle 1 stops into an energy supply station 3 for the purpose of receiving a charge, first an appropriate transport means, such as a transport robot means is used to remove the cassette-type batteries 2, after which the removed cassette-type batteries 2 are inserted into the shelves C of the storage space 12, the shelves C being caused to change to the second condition. They start a charging operation with respect to the cassette-type batteries 2, and an appropriate transport means, such as a transport robot means is used to remove the cassette-type batteries 2 that were stored in the shelves B and maintained at a charged condition, and install them into the electrical vehicle 1 in a prescribed location.

The electrical vehicle energy supply system 100 according to the present invention repeats the above-described operations, and can freely move the cassette-type batteries 2 within the electrical vehicle energy supply system, so that without the need for the owner or user of an electrical vehicle 1 needing to be aware of specific cassette-type batteries, it is possible to purchase the energy that is stored in a cassette-type battery for use as the source of drive for the electrical vehicle 1, this being in essence the operating mode of the subject system.

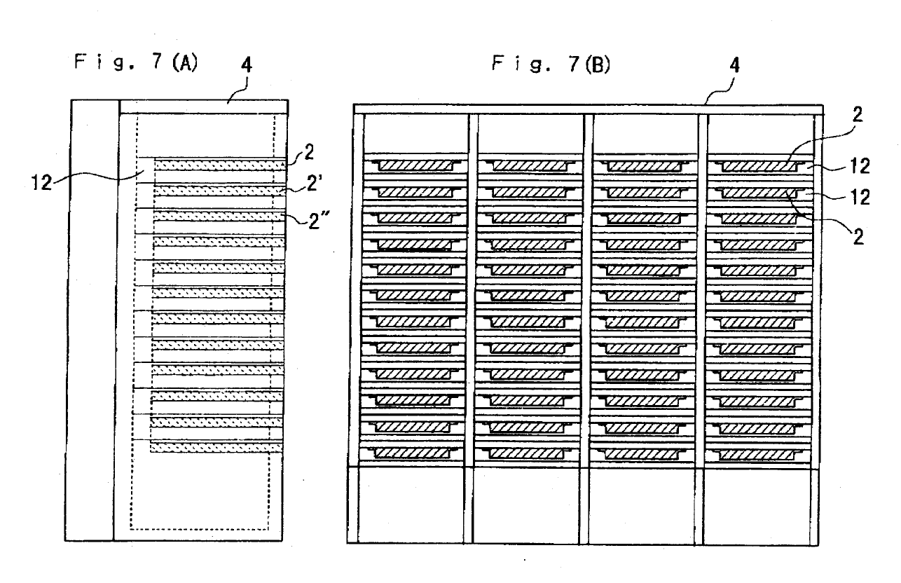

The overall configuration of the storage means 4 in the present invention and an example of the configuration of the various parts shelves or box parts 12 are shown in FIG. 7.

Each of the shelf groups A through C in the storage means 4 of the present invention can be disposed in a fixed manner, and can also, to improve the efficiency of the work of removing the cassette-type batteries 2 from the electrical vehicle 1, be configured so as to be movable.

It is desirable that an efficient transport means or robot means be used.

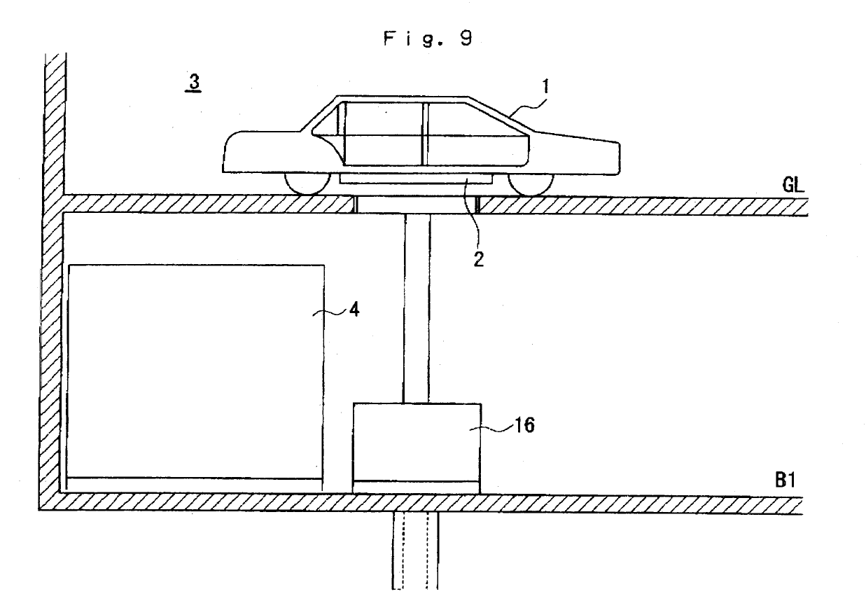

FIG. 9 is a cross-sectional view that shows an example of the configuration of an energy supply station 3 that is used in the electrical vehicle energy supply system 100 according to the present invention, in which the storage means 4 is disposed underground, a cassette-type battery 2 of an electrical vehicle 1 that is located on the ground level being removed by a transport means 16 that uses a hydraulic lift, and an already-charged cassette-type battery 2 being pulled out from an appropriate shelf part 12 of the storage means 4 and installed in a prescribed location in the electrical vehicle 1.

It is desirable that each of the storage spaces 12 be provided with a writing means and a reading means for reading and writing with respect to the storage means 8 provided in the batteries 2, the writing and reading means with respect to the storage means 8 of each battery provided in the storage space 12 are connected via a prescribed path to a central processor.

It is desirable that the means for executing a charging operation with respect to a group of batteries 2 that is stored within a storage space 12 within the battery storage section 4 include a high-speed charging means.

That is, it is desirable that a high-speed charging means 13 in the present invention perform charging of the batteries 2 at 1C to 6C for a period from 10 minutes to 1 hour.

Alternately, it is also desirable that a high-speed charging means 13 in the present invention perform charging of the batteries at 0.25C to 0.5C for a period from 2 to 4 hours.

As noted above, the third condition in the storage space 14 in the present invention is one in which a trickle charging operation is performed.

It is desirable that the plurality of storage spaces 14 in the present invention be minimally subdivided into the above-noted prescribed units.

The storage space 12 in the present invention can be moved by the above-noted units.

As described above, in the present invention a transport means 16 is provided for moving the batteries 2 between the battery storage section 4, which has the storage spaces 12 and the electrical vehicle 1.

Furthermore, in the present invention the transport means 16 is configured so as to remove the batteries from the prescribed location in the electrical vehicle 1, and store the batteries into a storage space that is in the first condition in the battery storage section of the energy supply station, after which it removes batteries from a storage space in the third condition in the energy supply station and installs them in the prescribed location in the electrical vehicle.

It is desirable that, when performing the replacement of the batteries 2 in an electrical vehicle 1, the prescribe control means that is provided in the energy supply station have a function of adjusting the relative position between the electrical vehicle 1 and the battery storage section 4, based on the stopped position of the electrical vehicle 1, and the position of a storage space in the battery storage section 4 that is in the first condition or the position of a storage space in the battery storage section 4 that is in the third condition.

In the present invention, in the central data processing means, each time a charging operation is performed with respect to each of the batteries that are to be charged, charging information is caused to be stored, a prescribed characteristic of the battery cells that form the battery is monitored before and after the charging, and, if a judgment is made that the prescribed characteristic value is outside a pre-established allowable range, alarm information that indicates the disposal of the battery is caused to be displayed on the display means provided in the battery.

In an energy supply system for an electrical vehicle according to the present invention, the amount of time for completion of replacement of a battery of the electrical vehicle is within 10 minutes and is desirably within 5 minutes.

In a battery distribution system in an electrical vehicle energy supply system according to the present invention, as described above, the batteries 2 are installed in the electrical vehicle 1 at the time of purchase of the vehicle. It is however also possible to enter into a contract with an energy supply station 3 so as to be registered therewith. A thusly registered battery 2 is managed by a computer so as to enable replacement of the battery at any charging station should the battery become depleted. For this reason, replacement is possible even in a remote location, if there is a charging station.

By using only the energy within the battery 2, as long as the contract remains in effect, use of the battery is guaranteed. If the contact is terminated, a registered battery can be purchased back by a charging station for a price that is established in accordance with the number of charges received up until that point and the period of time of use of the battery.

Should the battery become damaged due to an accident, it can be covered by insurance or the like, and if there is no insurance, it can be leased. The battery is thus not supplied as a battery itself, but rather simply as energy.

More specifically, at a charging station 3, a membership card is inserted into a card reader. The data from the card is read, and the registered condition is verified. If the verification is completed, the type of vehicle and type of battery is verified and the vehicle is driven to an automatic removal and installing apparatus, at which the batteries are removed from the electrical vehicle and inserted into a charging apparatus, these batteries being replaced by installing into the vehicle pre-charged batteries. By means of the IC card of the batteries that are inserted into the charging apparatus, a check is made of the discharge condition and history, and then the batteries are quickly charged. When the charging is completed, the charging is changed to a trickle charge, and data such as the times of completion of charging and charging time period are sent to the charging management computer to the main computer.

Of the cassette-type batteries in the present invention, one cassette is used to power such items as electronic equipment, illumination, CD players, radio cassette players, and safety equipment. The charging of this cassette is performed by the regenerative braking of a motor generator during braking when driving down a hill, this being used in combination with a solar battery.

Specific examples of a method of evaluating the amount to be charged for a charging in an electrical vehicle energy supply system 100 according to the present invention will differ, depending upon whether the user first purchases a new vehicle from a manufacturer with new cassettes in it and registers it, or purchases a vehicle with no battery cassettes.

Because of the finite lifetime of a battery, in the case of purchasing an electrical vehicle with new battery cassettes, the charges are established in terms of the charging time and maintenance fees.

If the contract is terminated midway, either the rental company or the battery supply company buys back the battery at the value of the battery at that point.

However, in the case of purchasing a new electrical vehicle without battery cassettes, a used cassette-type battery will be installed from a battery supply company.

In this case, a rental fee will be paid monthly. However, the rental charge will be adjusted by adding a charge for the number of charges and a maintenance fee.

In the case in which the batteries are managed as individually owned items, the amount of energy charged, that is, the fee for each charging can be established so as to be different, depending upon the age of the registration date.

In an energy supply station 3, charging of cassettes removed from a electrical vehicle 1 is performed, the method of charging used being that of supplying to each storage space 12 a required charging current from a high-voltage distribution panel and a quick-charging control panel, via a prescribed control circuit 13, so that the cassette-type batteries 2 are fully charged within a period of 30 to 60 minutes.

While there is no particular limitation on the above-noted operation of high-speed charging, it is desirable that the time to obtain a full charge be made 30 minutes to 60 minutes, by using a quick-charging method that is owned by the applicant and disclosed, for example, in Japanese patents 2739133, 2794003, 2732204, and 2743155 and in Japanese patent application No. 9-254667.

More specifically, the above method would be one of disposing a control chip which is a practical implementation of the above-noted patented technology into each of the shelves of each storage space, and having these chips perform the prescribed charging control.

By adopting the above-noted charging method, the charging time becomes short as indicated above, the result being that it is even possible to envision the owner of an electrical vehicle 1 returning after 60 minutes to reclaim his or her own cassette-type batteries, in which case only an at-cost cassette replacement fee would be paid.

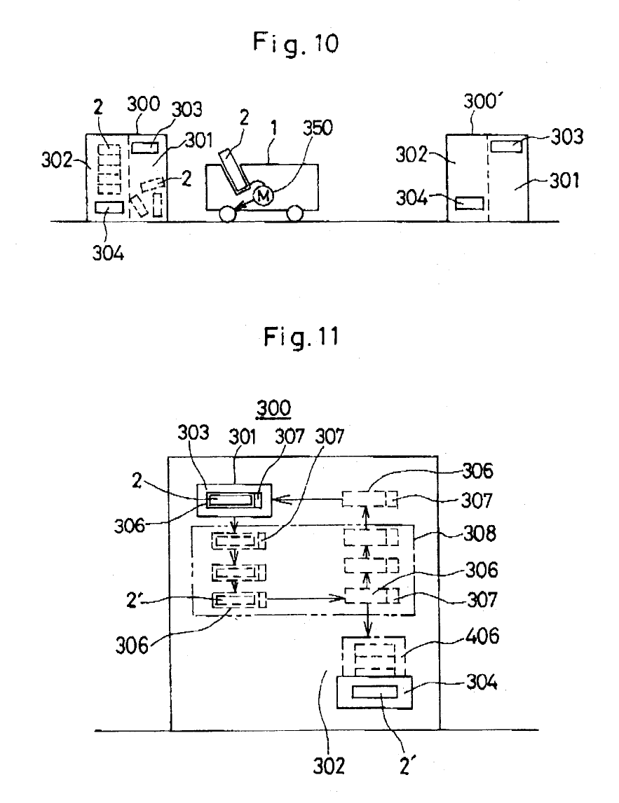

Next, another example of a simpler energy supply system for an electrical vehicle according to the present invention will be described in detail, with references being made to FIG. 10 and FIG. 11.

FIG. 10 is a drawing illustrating the general configuration of the second example of an energy supply system 100 for an electrical vehicle according to the present invention. This drawing shows an electrical vehicle energy supply system 100, which has an electrical vehicle 1 that runs under drive from an electrical motor 350 that uses a battery 2 as the drive source, and the cassette-type battery or batteries 2 which is removably installed in the electrical vehicles, and a battery storage location 300 for storage of cassette-type batteries 2 provided in proximity to the path of travel of the electrical vehicle 1. In the event that a need arises to replace a cassette-type battery 2 installed in the electrical vehicle 1, the owner or the user of the electrical vehicle 1 returns the battery 2 to the battery storage location 300, obtains from the battery storage location 300 a different cassette-type battery 2′ that has been charged, and installs this into the electrical vehicle.

In the electrical vehicle energy supply system 100 according to the present invention, it is desirable that the owner or user of the electrical vehicle 1 be able to purchase electrical energy stored in a cassette-type battery 2 or 2′ which is distributed by exchanging money via a battery storage location 300.

Additionally, in the electrical vehicle energy supply system 100 according to the present invention, it is desirable that the battery storage location 300 have a housing area 301 in which are housed cassette-type batteries 2 which either have no stored charge or have a charge that is below a prescribed level, and a battery storage part 302, in which cassette-type batteries 2′ which have been fully charged are stored. At the battery storage location 300, the owner or user of the electrical vehicle 1 returns to a battery return port 303 of the battery housing area 301 provided in the battery storage location 300 a used cassette-type battery 2 or a battery 2 which has fallen below a prescribed voltage from the electrical vehicle 1, and takes up a battery 2′ that has been fully charged and stored in the battery storage part 302 from a battery removal port 304 provided in the battery storage part 302, making a cash or card payment of a charge, if necessary, at the battery storage location, after which the owner or user installs the cassette-type battery 2′ into the electrical vehicle 1, and begins driving the electrical vehicle and, when it becomes necessary, the user stops by the same battery storage location 300 or a different battery storage location 300′ and replaces the cassette-type battery 2.

The fully charged cassette-type batteries 2′ stored at all times in the battery storage part 302 can be unused cassette-type batteries, and can also be used batteries that have be reclaimed and recharged. A distinction can be made between these two cases, and it is also possible to mix the two types of batteries.

In the battery storage location 300 of this example of the present invention, it is desirable, as shown in FIG. 11, that a charging area 305 be provided that has a function that charges the cassette-type battery 2.

That is, in this example of the present invention, the battery storage location 300 can be configured so as to perform prescribed charging, at the battery charging area 305, of a used cassette-type battery 2 that has been returned to the housing area 301 and to form a fully charged cassette-type battery 2.

In a specific example, a charging apparatus can be installed directly into the housing area 301, so that the housing area serves also as the charging area 305.

Another example is as shown in FIG. 11, in which a battery housing part 306 that accepts at least one cassette-type battery 2 is provided within the battery housing area 301, with a charging mechanism 307 that charges the cassette-type battery 2 being provided in the battery housing part 306.

In the above-noted example, it is desirable that the battery housing part 306 be movable within the battery storage location 300, so as enable the battery housing part 306 to move from the housing area 301 to a battery removal means 304 in the battery storage part 302 within the battery storage location 300.

More specifically, the battery housing part 306 is configured so that a cassette-type battery 2 is charged in a movement region 308.

It is desirable that the charging mechanism 307 include a high-speed charging means.

In the above-noted example, it is possible to adopt a configuration in which a plurality of battery housing parts 306 are provided, these being connected to an appropriate conveyor or linking movement means, the moving area 307 being caused to move in a circulating manner, so that, with an appropriate timing, it moves from a position that is opposite the battery return port 303 of the housing area 301, past a charging area 305, and via the storage part 302 so as to return to the battery housing area 301.

When a used cassette-type battery 2 is returned at the battery return port 303 battery housing part 306 moves by a prescribed amount with a timing at which the battery 2 is inserted into the battery housing port 306, so that an empty battery housing part 306 is positioned at the battery return port 303.

In response to the above, the battery housing part 306 into which a battery 2 was inserted moves to the battery charging area 305, at which the used cassette-type battery 2 is charged.

The cassette-type battery 2 is fully charged while the battery housing part 306 is moving in the battery charging area 305, and is stored at a prescribed position in the storage part 302, the then emptied battery housing part 306 being moved in response to the above-noted timing, so that it is returned to the housing area 301.

Next, as another example of an electrical vehicle energy supply system according to the present invention, there is a electrical vehicle energy supply system having an electrical vehicle that runs under drive from a cassette-type battery of a prescribed shape removably installed at a prescribed position in the electrical vehicle, and a cassette-type battery sales station, which stores at all times a plurality of cassette-type batteries that are either unused or have been recharged, this system being configured to enable an owner or a user of the electrical vehicle, if necessary, to replace a cassette-type battery installed in the owner or user's electrical vehicle with a battery that is stored at the cassette-type battery sales station.

In this example, it is desirable that the cassette-type battery sales station be configured as a battery storage location.

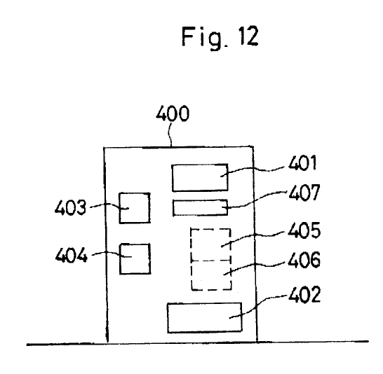

Because the cassette-type battery that is used in the present invention is much smaller than batteries of the past, it is possible, as shown in FIG. 12, to use an automatic vending machine to sell batteries at a charge directly to an owner or a user of an electrical vehicle, and it is alternately possible to use the batteries on a rental or lease basis.

Therefore, the automatic cassette-type battery vending apparatus 400 shown in FIG. 12 is placed in a required location, such as a bicycle shop, car dealer's shop, gasoline station, supermarket, or a parking lot, or at a corner or along the road. When the charge of a battery installed in an electrical vehicle becomes depleted, the owner or the user thereof returns the battery to the battery return part 401 of the automatic vending apparatus 400, removes either a recharged battery or an unused battery from a battery removal port 402, and installs this battery into the electrical vehicle.

When this is done, by providing in the automatic vending apparatus 400 a trading part 404 with a part into which is inserted cash payment, a prepaid card, or a cash card, and a keyboard or the like for keying in an ID number, and a display 403 capable of displaying the price of the electrical vehicle cassette-type battery, the input amount, the quantity purchased, and the amount of change, and the like, it is possible to complete a paid transaction for an electrical vehicle cassette-type battery.

More specifically, when a cassette-type battery for an electrical vehicle is to be replaced, the owner or user of the electrical vehicle, the automatic vending apparatus 400 automatically reads and makes a judgment as to whether it is a case of the charge being depleted and replacement being made by a different cassette-type battery, or the case in which the cassette-type battery of the electrical vehicle has reached the end of its life, and is to be replaced by a new, fully charged cassette-type battery that will be purchased, and displays the sales price accordingly.

It is possible that the price structure for rental or leasing in the above case will be different than the case of a sale.

Additionally, it is preferable that the automatic vending apparatus 400 have a function 405 within it capable of charging an electrical vehicle cassette-type battery, and in this case it is desirable that there be a high-speed charging system provided capable of charging at a rate of 4C or 6C.

Additionally, it is preferable that the above-noted high-speed charging system have a prescribed display means 407 for reading out, from a storage means various information with regard to the battery installed in the electrical vehicle.

It is desirable that the automatic vending apparatus 400 be provided with a charging maintenance means 406 for maintaining the charged condition of a cassette-type battery that has been charged.

That is, in another form of the present invention, the above-noted battery storage location or energy supply station is configured as a cassette-type battery vending apparatus which sells at least fully charged cassette-type batteries.

Additionally, another form of the present invention, is a cassette-type battery vending apparatus having at least one means selected from a group consisting of means for selecting a type of cassette-type battery that the purchaser wishes to purchase, means for displaying the price of the selected cassette-type battery, means for inserting cash, a prepaid card, or a cash card, means for executing a transaction, based on the type of cassette-type battery selected, the number thereof to be purchased, the inserted amount of cash or remaining balance on a prepaid card, and a cash card ID number or the like, and means for, after the transaction is completed, fetching and moving the selected type of cassette-type battery.

It is desirable that the above-noted cassette-type battery vending apparatus be an automated vending machine.

Further separate embodiment of the present invention will be explained hereunder.

Note that the separate embodiment of the present invention relates to an energy supplying system to an electrical vehicle, comprising, a plurality of standardized cassette-type batteries, a plurality of electrical vehicles each removably installing at least one of the standardized cassette-type batteries therein and running with electric energy provided from the standardized cassette-type battery as a driving source, a plurality of battery supplying stations each of which being individually located with far distance from each other and each storing a plurality of the standardized cassette-type batteries all time therein and each further comprising a battery supplying means for supplying a certain number of the standardized cassette-type batteries which the user of the electrical vehicle had designated, to a predetermined battery supplying section, if when a predetermined executing operation had been carried out, a battery receiving means for receiving a certain number of the standardized cassette-type batteries which the user of the electrical vehicle wishes to exchange therein, a charging means for charging the standardized cassette-type battery thus received and charged voltage value of which being reduced below a predetermined level and a housing means for keeping unused fully charged standardized cassette-type batteries or the fully charged and used standardized cassette-type batteries therein with performing auxiliary charging to each of the standardized cassette-type batteries thus kept therein, and wherein in the system, each one of the standardized cassette-type batteries is freely transferred among the plurality of stations and the plurality of the electrical vehicles.

The above-mentioned embodiment of the present invention, it would be preferable that each one of the standardized cassette-type batteries being provided with a predetermined memory means and wherein the system is configured so that with reference to information as stored in the memory means of the respective standardized cassette-type batteries, the system can control a transferring condition, number of charges, a current location, or condition of charging characteristic of the respective standardized cassette-type batteries, via a central processing means connected to each one of the stations.

More over, in the above-mentioned embodiment of the present invention, each of the stations being provided with a payment system connected to the central processing means and the payment system comprising an use-identifying means which including at least a means for directing money payment method of the user of the standardized cassette-type battery accompanied by user-ID information given to the user of the standardized cassette-type battery of the electrical vehicles, an input means which can accept the use-identifying means therein and provided with a data inputting device through which the user can input data corresponding to the number of the standardized cassette-type batteries which the use wishes to be supplied from the system, a money deducting means for charging a certain amount of money to the user with reference to the input data input into the input means and with reference to the information about the payment system of the user from information given in the use-identifying means, deducting a certain amount of money from a bank account of the user and a battery moving means for moving a certain amount number of the standardized cassette-type batteries the number of which had been set by the user, are transferred to the battery supplying section after the predetermined money had been deducted from designated bank account of the user by the money deducting means, has been completed.

Further, in this embodiment, the central processing means and each one of a plurality of the stations being connected to each other through wiring or wireless communication lines as well as through an internet.

By adopting the constitution as described in detail above, an electrical vehicle energy supply system according to the present invention, it is possible supply electrical energy to an electrical vehicle with a convenience that is equivalent to the case of a gasoline vehicle, thereby greatly contributing to the achievement of a practically usable electrical vehicle.

What is claimed is:

1. An electrical vehicle energy supply system comprising:
an electrical vehicle running on drive from an electric motor driven by a battery;
a cassette-type battery removably installed in said electrical vehicle; and
a battery storage location for said cassette-type battery provided in proximity to a path of travel of said electrical vehicle, wherein when it is necessary to replace a cassette-type battery installed in said electrical vehicle, an owner or user thereof returns said battery to any one of said battery storage locations, obtains a replacement charged cassette-type battery in exchange of said returned battery, and installs said replacement battery into said electrical vehicle.

2. An electrical vehicle energy supply system according to claim 1, wherein an owner or user of said electrical vehicle, purchases at a charge electrical energy stored in a cassette-type battery distributed via said battery storage location, by either purchase, rental, or lease of said battery.

3. An electrical vehicle energy supply system according to either claim 1 or claim 2, wherein said battery storage location has a function capable of selling either an already charged cassette-type battery or an unused cassette-type battery.

4. An electrical vehicle energy supply system according to any one of claim 1 to claim 3, wherein said battery storage location comprises a housing area for a cassette-type battery with no charge or with a charge below a prescribed level, and a battery storage part for storing a prescribed number of fully charged cassette-type batteries at all times.

5. An electrical vehicle energy supply system according to any one of claim 1 to claim 4, wherein said battery storage location comprises a charging area having a function capable of charging said cassette-type battery.

6. An electrical vehicle energy supply system according to any one of claim 1 to claim 5, wherein said battery storage part of said battery storage location stores either unused fully charged cassette-type batteries, or fully recharged batteries, or both types of cassette-type batteries.

7. An electrical vehicle energy supply system according to any one of claim 4 to claim 6, wherein said battery storage location performs prescribed charging of a used cassette-type battery that is returned to within said housing area at said charging area, so as to form a fully charged cassette-type battery.

8. An electrical vehicle energy supply system according to claim 7, wherein said housing area is used also as a charging area.

9. An electrical vehicle energy supply system according to claim 8, wherein, within said housing area at least a battery housing part is provided, within which is provided a charging mechanism for charging said cassette-type battery.

10. An electrical vehicle energy supply system according to claim 9, wherein said battery housing part is movable within said battery storage location.

11. An electrical vehicle energy supply system according to claim 10, wherein said battery housing can move toward means for removing a cassette-type battery from said battery storage part within said battery storage location.

12. An electrical vehicle energy supply system according to any one of claim 9 to claim 11, wherein said battery housing part charges a cassette-type battery in a movement region.

13. An electrical vehicle energy supply system according to claim 12, wherein said charging includes means for high-speed charging.

14. An electrical vehicle energy supply system according to any one of claim 1 to claim 13, wherein said cassette-type battery has a uniform specification for each type of electrical vehicle in which said cassette-type battery is used.

15. An electrical vehicle energy supply system comprising:
an electrical vehicle having installed at a prescribed location therein a cassette-type battery of a prescribed shape; and
a cassette-type battery sales station that stores at all times a plurality of fully charged unused cassette-type batteries, or fully recharged used cassette-type batteries, wherein if necessary an owner or user of said electrical vehicle replaces a cassette-type battery installed in the electrical vehicle of the owner or user with a cassette-type battery stored at said cassette-type battery sales station.

16. An electrical vehicle energy supply system according to any one of claim 1 to claim 14, wherein said cassette-type battery sales station is a battery storage location.

17. An energy supply system for an electric vehicle, comprising:
an electrical vehicle which carries in a prescribed location a freely removable cassette-type battery of a prescribed shape; and
an energy supply station which has at all times a plurality of said cassette-type batteries of a prescribed shape and which performs charging processing individually with respect to groups of said batteries and serves the function of storing said batteries in a fully charged condition,
wherein when said electrical vehicle enters said energy supply station, part or all of a group of prescribed number of said batteries are removed therefrom, these being replaced by battery groups of an equal number of fully charged batteries that had been stored at said energy supply station, the single or multiple batteries that had been removed from said electrical vehicle being charged, the electrical vehicle heading toward a next energy supply station and said energy supply station awaiting the arrival of a next electrical vehicle.

18. An energy supply system for an electric vehicle, comprising:
an electrical vehicle which carries in a prescribed location a freely removable cassette-type battery of a prescribed shape; and
an energy supply station which has at all times a plurality of said cassette-type batteries of a prescribed shape, and which performs charging processing of units of said batteries which include the number of batteries required by one said electrical vehicle, and serves the function of storing said batteries in a fully charged condition,
wherein when said electrical vehicle enters said energy supply station, all of said batteries are removed therefrom, these being replaced by an equal number of fully charged batteries that had been stored at said energy supply station, the single or multiple batteries that had been removed from said electrical vehicle being charged, the electrical vehicle heading toward a next energy supply station and said energy supply station awaiting the arrival of a next electrical vehicle.

19. An energy supply station according to any one of claim 1 to claim 18, wherein said battery cassette that is carried in said electrical vehicle is of flat construction in which a plurality of flat battery cells are arranged in a planar manner, and further wherein an electrical connection is made to said driving means by merely insertion into a prescribed position in said electrical vehicle.

20. An energy supply station according to claim 19, wherein a plurality of said flat batteries carried in said electrical vehicle are arranged in a planar manner.

21. An energy supply station according to claim 19, wherein a plurality of said flat batteries carried in said electrical vehicle are arranged by stacking in a three-dimensional manner.

22. An energy supply station according to claim 19, wherein a flat part of a plurality of said flat batteries carried in said electrical vehicle are arranged vertically at a prescribed angle with respect to a horizontal plane and further wherein said plurality of vertically oriented flat batteries are mutual adjacent so as to be grouped in a three-dimensional manner.

23. An energy supply system according to any one of claim 1 to claim 22, wherein said battery is configured so that said battery cell is covered by an outer frame of an appropriate material, part of said outer frame comprising an electrical connection part enabling free connection and breaking of connection with respect to the drive part of the electrical vehicle or to various machinery or control equipment thereof.

24. An energy supply system according to any one of claim 1 to claim 23, wherein said individual cassette-type battery comprise means for storing information with regard to the charging condition, number of charges, remaining capacity, and internal resistance of the cell contained therein, and information such as information with regard to the life, of said cell and the owner or user, and means for selectively displaying information that is stored in said storage means.

25. An energy supply system according to claim 24, wherein said individual cassette-type battery further comprises means for selectively switching information stored in said storage means that is to be displayed.

26. An energy supply system according to claim 24, wherein said storage means is one type of storage means selected from a group consisting of a semiconductor storage mechanism, an optical storage mechanism, a magnetic storage mechanism, and a storage means making use of an atom or molecule.

27 An energy supply system according to claim 24, wherein said storage means is one type of storage means selected from a group consisting of a non-contact semiconductor storage mechanism, an optical storage mechanism, a magnetic storage mechanism, and a storage mechanism making use of an atom or molecule.

28. An energy supply system according to claim 26 or claim 27, wherein said storage means is an IC card.

29. An energy supply system according to any one of claim 1 to claim 28, wherein said energy supply station comprises a storage space for storing, as a unit, the number of cassette-type batteries required by one electrical vehicle, or a storage space for storing, as a unit, part of the number of cassette-type batteries required by one electrical vehicle, said energy supply station having a function of either simultaneously charging the group of batteries stored in said storage space or of performing processing that maintains the charged condition of said group of batteries for which charging has been completed.

30. An energy supply system according to claim 29, wherein said energy supply station comprises battery storage section having a plurality of said storage spaces, and further wherein a plurality of storage spaces forming said battery storage section are disposed in a prescribed arrangement.

31 An energy supply system according to claim 29 or claim 30 having a function whereby at least part of a group of batteries that have been charged are provided in return for payment.

32. An energy supply system according to any one of claim 1 to claim 31, wherein each of said storage spaces in said battery storage section is configured so as to be selectively placed in any of three condition, said conditions being a first condition, in which said space does not hold a battery, a second condition, in which said space holds a battery and said battery is being charged, and a third condition, in which said space holds a battery and charging processing is performed to maintain the charge thereof.

33. An energy supply system according to any one of claim 24 to claim 32, wherein each of said storage spaces comprises a writing means and a reading means with respect to said storage means provided in said battery.

34. An energy supply system according to any one of claim 1 to claim 33, wherein said writing means and said reading means that are provided in said storage space with respect to said storage means of said battery, are connected, via a prescribed path, to a central processor.

35. An energy supply system according to any one of claim 1 to claim 34, wherein a means for performing a charging operation with respect to a group of batteries held in said storage spaces of said battery storage section includes a high-speed charging means.

36. An energy supply system according to claim 35, wherein said high-speed charging means performs charging of said battery at 1C to 6C for a period from 10 minutes to 1 hour or at 0.25C to 0.5C for a period from 2 to 4 hours.

37. An energy supply system according to claim 32, wherein said third condition in said storage space is a condition in which an appropriate operation of supplemental charging is performed, said operation including a trickle charging operation for maintaining the charged condition of said battery being charged.

38. An energy supply system according to any one of claim 1 to claim 37, wherein said plurality of storage spaces are arranged in a three-dimensional shelf.

39. An energy supply system according to any one of claim 1 to claim 37, wherein said plurality of storage spaces are arranged in a planar manner so as to be mutually adjacent.

40. An energy supply system according to claim 38 or claim 39, wherein said plurality of storage spaces have a space suitable for the storage of at least one said battery.

41. An energy supply system according to claim 38 or claim 39, wherein said plurality of storage spaces are divided into subdivisions suitable for the storage of prescribed units of said batteries.

42. An energy supply system according to any one of claim 1 to claim 41, wherein part or all of said storage spaces can be moved.

43. An energy supply system according to any one of claim 1 to claim 42, wherein between said battery storage section, which has said storage space, and said electrical vehicle, a transport means is provided to transport said battery.

44. An energy supply system according to any one of claim 1 to claim 43, wherein after said battery is removed from its prescribed position in said electrical vehicle and housed in said storage space of said battery storage section of said energy supply station, said storage space being in said first condition, a battery which is located in a storage space that is in said third condition at the energy supply station is removed therefrom and installed in the prescribed location in said electrical vehicle.

45. An energy supply system according to claim 44, wherein, when charging the battery of said electrical vehicle, a prescribed control means that is provided in said energy supply station has a function of adjusting the relative position between said electrical vehicle and said battery storage section, based on the stopping position of said electrical vehicle, and the position of a storage space that is in the first condition or the position of a storage space that is in the third condition.

46. An energy supply system according to any of claim 1 to claim 45, wherein said energy supply system has a function whereby, each time charging is performed of individual batteries that are to be charged, said charging information is stored, a prescribed characteristics of the battery cell of said battery being monitored before and after charging and, if a judgment is made that said characteristic is outside a prescribed range, alarm information indicating disposal of said battery is caused to be displayed on said display means provided in said battery.

47. An energy supply system according to claim 46, wherein said prescribed characteristic value of said battery cell is an internal resistance of said cell.

48. An energy supply system according to any one of claim 1 to claim 47, wherein the amount of time for completion of replacement of a battery of said electrical vehicle is within 10 minutes, and preferably within 5 minutes.

49. An electrical vehicle cassette-type battery comprising an outer housing with a flat configuration and at least one cell housed within said outer housing, installable in a prescribed position of an arbitrary electrical vehicle, which, by insertion into said prescribed position achieves a prescribed electrical connection with an electrical system of said electrical vehicle.

50. An electrical vehicle cassette-type battery sold, rented, or leased in an electrical vehicle energy supply system according to any one of claim 1 to claim 48.

51. An electrical vehicle battery according to claim 49 or claim 50, having a flat configuration of a plurality of flat battery cells arranged in a planar manner, said battery cells being installed in said electrical vehicle in a flat or vertical orientation so as to enable free installation into and removal therefrom.

52. An electrical vehicle battery according to any one of claim 49 to claim 51, wherein said individual cassette-type batteries comprise means for storing information with regard to the charging condition, number of charges, remaining capacity, and internal resistance of the cell contained therein, and information such as information with regard to the life, of said cell and the owner or user, and means for selectively displaying information that is stored in said storage means.

53. An electrical vehicle battery according to claim 49 or claim 52, wherein said individual cassette-type batteries further comprises means for selectively switching information stored in said storage means that is to be displayed.

54. An electrical vehicle battery according to claim 52 or claim 53, wherein said storage means is at least one type selected from a group consisting of a semiconductor storage mechanism, an optical storage mechanism, a magnetic storage mechanism, and a storage means making use of an atom or molecule.

55. An electrical vehicle battery according to claim 54, wherein said storage means is at least one non-contact type selected from a group consisting of a semiconductor storage mechanism, an optical storage mechanism, a magnetic storage mechanism, and a storage means making use of an atom or molecule.

56. An electrical vehicle battery according to claim 54 or claim 55 wherein said storage means is an IC card.

57. An electrical vehicle battery storage and charging apparatus comprising a storage space for housing at least part of the cassette-type batteries required by one said electrical vehicle or all such batteries as a unit, wherein within said storage space is provided a function of either simultaneously charging the group of batteries stored in said storage space or of performing processing that maintains the charged condition of said group of batteries for which charging has been completed.

58. An electrical vehicle battery storage and charging apparatus according to claim 57, comprising a battery storage section having a plurality of said storage spaces, and further wherein a plurality of storage spaces forming said battery storage section are disposed in a prescribed arrangement.

59. An electrical vehicle battery storage and charging apparatus according to claim 57 or claim 58, wherein each of said storage spaces in said battery storage section is configured so as to be selectively placed in any of three condition, said conditions being a first condition, in which said space does not hold a battery, a second condition, in which said space holds a battery and said battery is being charged, and a third condition, in which said space holds a battery and charging processing is performed to maintain the charge thereof.

60. An electrical vehicle battery storage and charging apparatus according to any one of claim 57 to claim 59, wherein each of said storage spaces provided in said battery storage section comprises a writing means and a reading means with respect to-said storage means provided in said battery.

61. An electrical vehicle battery storage and charging apparatus according to claim 60, wherein said writing means and said reading means that are provided in said storage space with respect to said storage means of said battery, are connected, via a prescribed path, to a central processor.

62. An electrical vehicle battery storage and charging apparatus according to any one of claim 57 to claim 61, wherein a means for performing a charging operation with respect to a group of batteries held in said storage spaces of said battery storage section includes a high-speed charging means.

63. An electrical vehicle battery storage and charging apparatus according to any one of claim 57 to claim 62, wherein said high-speed charging means performs charging of said battery at 1C to 6C for a period from 10 minutes to 1 hour.

64. An electrical vehicle battery storage and charging apparatus according to claim 59, wherein said third condition in said storage space is a condition in which an appropriate operation of supplemental charging is performed, said operation including a trickle charging operation for maintaining the charged condition of said battery being charged.

65. An electrical vehicle battery storage and charging apparatus according to any one of claim 57 to claim 64, wherein said plurality of storage spaces are arranged in a three-dimensional shelf.

66. An electrical vehicle battery storage and charging apparatus according to any one of claim 57 to claim 65, wherein said plurality of storage spaces are arranged in a planar manner so as to be mutually adjacent.

67. An electrical vehicle battery storage and charging apparatus according to either claim 65 or claim 66, wherein said plurality of storage spaces have a space suitable for the storage of at least one said battery.

68. An electrical vehicle battery storage and charging apparatus according to either claim 65 or claim 66, wherein said plurality of storage spaces are divided into subdivisions suitable for the storage of prescribed units of said batteries.

69. An electrical vehicle battery storage and charging apparatus according to any one of claim 57 to claim 68, wherein part or all of said storage spaces can be moved.

70. An electrical vehicle battery storage and charging apparatus according to any one of claim 57 to claim 69, wherein between said battery storage section, which has said storage space, and said electrical vehicle, a transport means is provided to transport said battery.

71. An electrical vehicle battery management system in which each flat cassette-type battery configured to enable it to be freely installed into and removed from an electrical vehicle comprises means for storing information with regard to the charging condition, number of charges, remaining capacity, and internal resistance of the cell contained therein, and information such as information with regard to the life, of said cell and the owner or user thereof, and means for selectively displaying information that is stored in said storage means, and wherein the history and characteristics of said batteries are monitored from various information stored in said storage means, a judgment being made at all times as to the usability of said battery.

72. A battery management system configured so that each time charging individual batteries to be charged is performed, charging information is stored and a prescribed characteristic of battery cell of said battery is monitored before and after charging and, if a judgment is made that said characteristic is outside a prescribed range, alarm information indicating disposal of said battery is caused to be displayed on a display means of provided in said battery.

73. A cassette-type battery supply apparatus for which a battery storage location recited in any one of claim 1 to claim 13 or an energy supply station recited in any one of claim 15 to claim 44 is a vending machine minimally selling fully charged cassette-type batteries.

74. A cassette-type battery supply apparatus according to claim 73, wherein said cassette-type battery has a construction as recited in any one of claim 21 to 24, and claim 45 to claim 49.

75. A cassette-type battery supply apparatus according to claim 72 or 73, wherein said apparatus having at least means for selecting a type of cassette-type battery that a purchaser wishes to purchase, means for displaying a price of said selected cassette-type battery, means for inserting cash, a prepaid card, or a cash card, means for executing a transaction, based on the type of said cassette-type battery selected, the number thereof to be purchased, the inserted amount of cash or remaining balance on a prepaid card, and a cash card ID number or the like, and means for, after the transaction is completed, moving the selected type of cassette-type battery to a means for the battery to be fetched.

76. A cassette-type battery supply apparatus according to any one of claim 72 to claim 74, wherein said cassette-type battery vending apparatus is an automated vending machine.

77. A method for supplying energy to an electrical vehicle, comprising:
priorly storing a standardized cassette-type battery in a plurality of prescribed battery storage areas in a station;
visiting said station by a electrical vehicle into which is installed at least one said cassette-type battery and verifying an owner or user of said electrical vehicle;
replacing, after verification of said owner or user, part or all of said cassette-type batteries installed in said electrical vehicle with one or a plurality of said fully charged cassette-type batteries stored in said station, and then execution a payment transaction;
moving said electrical vehicle away from said station after said payment is completed;
detecting of a charging condition of each battery newly stored in said battery storage when batteries left at said station and stored therein and performing a high-speed charging of a battery that indicates a charge level below a prescribed charge level;
supplementally charging all batteries having reached a prescribed charge condition in said battery storage area; and
recording of control information with regard to an owner or user of said vehicle, usage of each of said cassette-type batteries, recording of a number of charges, a current location, and whether or not a disposal criterion has been satisfied,
wherein said steps are executed by means of computer processing.

78. A method for supplying energy to an electrical vehicle according to claim 77, wherein an information storage means for storing said control information is installed individually in each of said standardized cassette-type batteries.

79. A method for supplying energy to an electrical vehicle according to claim 77, wherein a cell function condition detecting means which detects whether a functional loss has occurred in any cell making up said battery is provided in cassette-type battery.

80. An energy supplying system to an electrical vehicle, comprising:
a plurality of standardized cassette-type batteries;
a plurality of electrical vehicles each removably installing at least one of said standardized cassette-type batteries therein and running with electric energy provided from said standardized cassette-type battery as a driving source;
a plurality of battery supplying stations each of which being individually located with far distance from each other and each storing a plurality of said standardized cassette-type batteries all time therein and each further comprising a battery supplying means for supplying a certain number of said standardized cassette-type batteries which said user of said electrical vehicle had designated, to a predetermined battery supplying section, if when a predetermined executing operation had been carried out, a battery receiving means for receiving a certain number of said standardized cassette-type batteries which said user of said electrical vehicle wishes to exchange therein, a charging means for charging said standardized cassette-type battery thus received and charged voltage value of which being reduced below a predetermined level and a housing means for keeping unused fully charged standardized cassette-type batteries or said fully charged and used standardized cassette-type batteries therein with performing auxiliary charging to each of said standardized cassette-type batteries thus kept therein, wherein in said system, each one of said standardized cassette-type batteries is freely transferred among said plurality of stations and said plurality of said electrical vehicles.

81. An energy supplying system to an electrical vehicle according to claim 80, wherein each one of said standardized cassette-type batteries being provided with a predetermined memory means and wherein said system is configured so that with reference to information as stored in said memory means of the respective standardized cassette-type batteries, said system can control a transferring condition, number of charges, a current location, or condition of charging characteristic of said respective standardized cassette-type batteries, via a central processing means connected to each one of said stations.

82. An energy supplying system to an electrical vehicle according to claim 80 or 81, wherein, each of said stations being provided with a payment system connected to said central processing means and said payment system comprising an use-identifying means which including at least a means for directing money payment method of said user of said standardized cassette-type battery accompanied by user-ID information given to said user of said standardized cassette-type battery of said electrical vehicles, an input means which can accept said use-identifying means therein and provided with a data inputting device through which said user can input data corresponding to the number of said standardized cassette-type batteries which said use wishes to be supplied from said system, a money deducting means for charging a certain amount of money to said user with reference to said input data input into said input means and with reference to said information about the payment system of said user from information given in said use-identifying means, deducting a certain amount of money from a bank account of said user and a battery moving means for moving a certain amount number of said standardized cassette-type batteries said number of which had been set by said user, are transferred to said battery supplying section after said predetermined money had been deducted from designated bank account of said user by said money deducting means, has been completed.

83. An energy supplying system to an electrical vehicle according to any one of claims 80 to 82, wherein, said central processing means and each one of a plurality of said stations being connected to each other through wiring or wireless communication lines as well as through an internet.
